(19) United States
(12) Patent Application Publication
(10) Pub. No.: US 2012/0151349 A1
(43) Pub. Date: Jun. 14, 2012

(54) APPARATUS AND METHOD OF MAN-MACHINE INTERFACE FOR INVISIBLE USER

(75) Inventors: Young Kwon HAHM, Daejeon-si (KR); Dong Joon CHOI, Daejeon-si (KR); Soo In LEE, Daejeon-si (KR)

(73) Assignee: Electronics and Telecommunications Research Institute, Daejeon-si (KR)

(21) Appl. No.: 13/314,786

(22) Filed: Dec. 8, 2011

(30) Foreign Application Priority Data
Dec. 8, 2010 (KR) 10-2010-0125186

(51) Int. Cl. G06F 3/16

(52) U.S. Cl. 715/727

(57) ABSTRACT

Man-machine interface apparatus and method for an user are provided. The man-machine interface apparatus includes: a touch recognizing unit recognizing a touch by the invisible user; and a voice notifying unit notifying the invisible user of a name of a menu or application service corresponding to the touched position through a voice.

### CROSS-REFERENCE TO RELATED APPLICATIONS

This application claims the benefit of priority of Korean Patent Application No. 10-2010-0125186 filed on Dec. 8, 2010, all of which are incorporated by reference in their entirety herein.

### BACKGROUND OF THE INVENTION

1. Field of the Invention

The present invention relates to man-machine interface apparatus and method for an invisible user, and more particularly, to man-machine interface apparatus and method capable of allowing an invisible user to easily use a portable terminal.

2. Related Art

As an existing technology of providing a service such as a web service, etc., an invisible user using a portable terminal such as a smart phone, there may be a voice based service technology such as a VoiceXML based web service, etc.

Here, the invisible user may use a voice and the input of a character through a keyboard as a method for inputting command and information, and a terminal for the invisible user may exchange information with the invisible user through voice response of next usable menu description, a message, etc.

However, in the case in which the command is issued through the voice, when there is large noise in the surrounding environment, a voice recognition rate is deteriorated, such that it may be difficult to use the voice. For example, it may be difficult to use the voice, in environments like a conference, etc.

An ear phone is used, thereby making it possible to allow the voice generated from the terminal not to be heard by other people; however, the voice of the user cannot help being heard by other people. Meanwhile, in the case in which the command is input through the keyboard, when a button type of the keyboard is changed into a touch screen type as in the smart phone, a position of the keyboard or the menu may not be recognized, thereby making it impossible to issue the command.

### SUMMARY OF THE INVENTION

The present invention provides man-machine interface apparatus and method for an invisible user capable of allowing the invisible user to easily use a touch screen-type portable terminal such as a smart phone, when he/she intends to use the portable terminal, by combining a touch with voice guidance or the input of a character with the voice guidance.

In an aspect, a man-machine interface apparatus for an invisible user is provided. The man-machine interface apparatus includes: a touch recognizing unit recognizing a touch by the invisible user; and a voice notifying unit notifying the invisible user of a name of a menu or application service corresponding to the touched position through a voice.

In another aspect, a man-machine interface method for an invisible user is provided. The man-machine interface method includes: switching a mode of a portable terminal into an invisible user mode; notifying the invisible user of a name and a position of a menu or an application service through a voice; and recognizing a touch by the invisible user and notifying the invisible user of a name of a menu or application service corresponding to a position of the touch through the voice.

In another aspect, a man-machine interface method for an invisible user is provided. The man-machine interface method includes: switching a mode of a portable terminal into an invisible user mode; notifying the invisible user of a name an identification number of a menu or an application service through a voice; and recognizing a character handwritten by the invisible user and notifying the invisible user of a name of a menu or application service corresponding to the recognized character through the voice.

### BRIEF DESCRIPTION OF THE DRAWINGS

FIG. 1 is a block diagram describing a man-machine interface apparatus according to an exemplary embodiment of the present invention.

FIG. 2 is a flow chart describing a man-machine interface method according to another exemplary embodiment of the present invention.

FIG. 3 is a flow chart describing a man-machine interface method according to another exemplary embodiment of the present invention.

FIG. 4 is a flow chart describing a man-machine interface method according to another exemplary embodiment of the present invention.

### DESCRIPTION OF EXEMPLARY EMBODIMENTS

Advantages and features of the present invention and methods to achieve them will be elucidated from exemplary embodiments described below in detail with reference to the accompanying drawings. However, the present invention is not limited to exemplary embodiment disclosed herein but will be implemented in various forms. The exemplary embodiments make disclosure of the present invention thorough and are provided so that those skilled in the art can easily understand the scope of the present invention. Therefore, the present invention will be defined by the scope of the appended claims. Meanwhile, terms used in the present invention are to explain exemplary embodiments rather than limiting the present invention. Unless explicitly described to the contrary, a singular form includes a plural form in the present specification. “Comprises” and “comprising” used herein does not exclude the existence or addition of one or more other components, steps, operations and/or elements other than stated components, steps, operations, and/or elements.

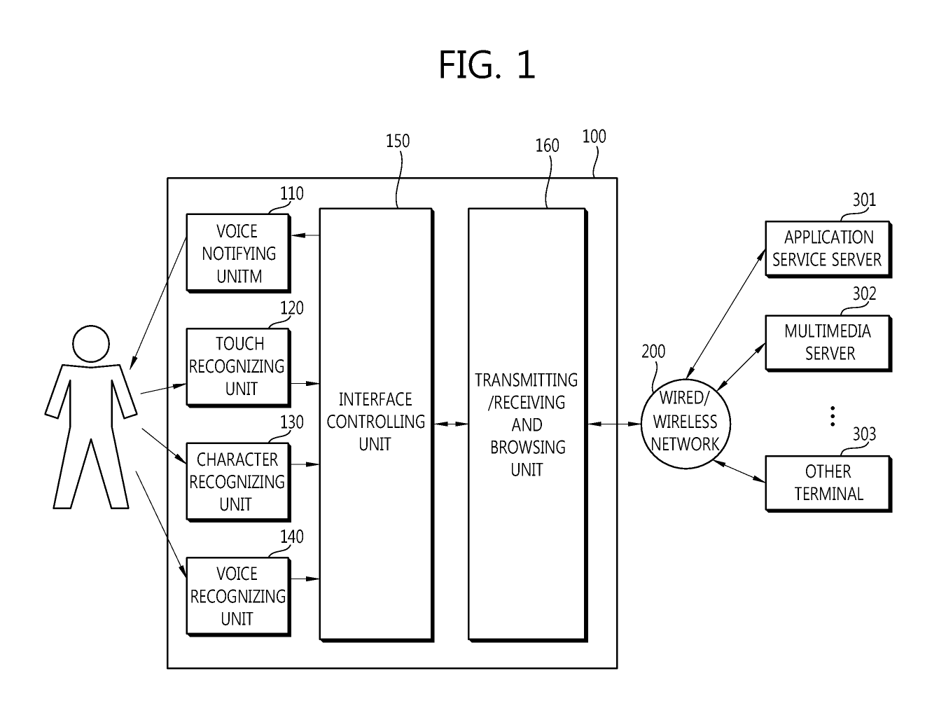

A man-machine interface apparatus according to an exemplary embodiment of the present invention will be described with reference to FIG. 1. FIG. 1 is a block diagram describing a man-machine interface apparatus according to an exemplary embodiment of the present invention.

Referring to FIG. 1, a man-machine interface apparatus 100 according to an exemplary embodiment of the present invention is configured to include a voice notifying unit 110, a touch recognizing unit 120, a character recognizing unit 130, a voice recognizing unit 140, an interface controlling unit 150, and a transmitting/receiving and browsing unit 160.

The man-machine interface apparatus 100, which is, for example, a portable man-machine interface apparatus 100 for an invisible user, may be connected to an application service server 301 or a multimedia server 302 or communicate with other terminal 303, through a wired/wireless network 200.

More specifically, the touch recognizing unit 120 recognizes a touch by a user (hereinafter, a case in which the user is the invisible user will be described by way of example). For example, the touch recognizing unit 120 may be a touch screen, and may recognize a position on the touch screen touched by the invisible user.

The voice notifying unit 110 notifies the invisible user of a name of a menu or application service corresponding to the position touched by the invisible user through a voice. That is, the voice notifying unit 110 may notify the invisible user of what the invisible user touches among menus or application services displayed on the touch screen through the voice.

The voice notifying unit 110 may first notify the invisible user of names and positions of the menu or the application service through the voice in order to guide the invisible user to touch a desired menu or application service.

For example, when the touch screen is divided in a matrix form, the voice notifying unit 110 maps elements of each matrix to the numbers, thereby making it possible to notify the invisible user of the numbers of positions at which the menus or the application services are disposed on the touch screen through the voice.

Here, the interface controlling unit 150 may serve as an interface between the touch recognizing unit 120 and the voice notifying unit 110. For example, the interface controlling unit 150 may provide information on the touch by the user recognized by the touch recognizing unit 120 to the voice notifying unit 110.

Here, the voice notifying unit 110 may be, for example, a text to speech (TTS) module, and may convert the information on the touch provided from the interface controlling unit 150 from a text type into the voice and output the converted voice.

Meanwhile, the character recognizing unit 130 recognizes a character input by the invisible user. For example, the character recognizing unit 130 may recognize a character handwritten by the invisible user or may recognize a printed character presented by the invisible user. When the invisible user inputs a name, an identification number, or an identification character of the desired menu or application service, the character recognizing unit 130 recognizes the name, the identification number, or the identification character of the menu or application service input by the invisible user.

Here, the voice notifying unit 110 notifies the invisible user of the character recognized by the character recognizing unit 130 through the voice. The voice notifying unit 110 may receive information on the character recognized by the character recognizing unit 130 through the interface controlling unit 150 and output the received information through the voice.

That is, the voice notifying unit 110 may notify the invisible user of what menu's or application service's name (or identification number, identification character) the character input by the invisible user is.

The voice recognizing unit 140 receives a voice about the menu or application service desired by the invisible user or information required by the invisible user from him/her, and recognizes the received voice as the character to provide it to the interface controlling unit 150. In order to confirm the recognized voice, the voice notifying unit 110 may receive information on the recognized voice and convert the received information into the voice to output the voice to the invisible user.

Meanwhile, the interface controlling unit 150 may perform the menu or application service selected by the invisible user using at least any one of the touch, the character, and the voice.

For example, when the name notified through the voice by the voice notifying unit 110 is a name of a target menu or application service to be selected by the invisible user, the interface controlling unit 150 may perform the menu or application service corresponding to the position touched by the invisible user. Alternatively, the interface controlling unit 150 may perform the menu or application service corresponding to the character or the voice input by the invisible user.

The interface controlling unit 150 may directly perform the menu or the application service or may control the transmitting/receiving and browsing unit 160, thereby being connected to the application service server or the multimedia server, such as a VoiceXML based web server, etc., according to the menu or the application service. Alternatively, the interface controlling unit 150 may control the transmitting/receiving and browsing unit 160, thereby communicating with other terminals through the wired/wireless network.

For example, when names and identification numbers are allocated to each of the menus or the application services, the transmitting/receiving and browsing unit 160 may perform the menu or application service corresponding to the number. When the invisible user selects the menu or the application service, the interface controlling unit 150 may provide the number corresponding to the selection to the transmitting/receiving and browsing unit 160, such that the transmitting/receiving and browsing unit 160 may perform the menu or application service corresponding to the number.

Hereinafter, a process of whether the name notified through the voice by the voice notifying unit 110 is the name of the target menu or application service to be selected by the invisible user will be described in more detail.

The interface controlling unit 150 may determine that the name notified through the voice is the name of the target menu or application service to be selected by the invisible user when a confirmation signal is input from the invisible user. The confirmation signal may be input by various methods.

For example, the confirmation signal may be input by performing a touch in a scheme predetermined by the invisible user. Alternatively, the confirmation signal may be input through voice input by the invisible user. Alternatively, when a selection button receiving an instruction from the invisible user is provided, the confirmation signal may be input through the operation of the selection button by the invisible user.

Alternatively, the interface controlling unit 150 may determine that the name notified through the voice is the name of the target menu or application service to be selected by the invisible user when the touch by the invisible user is maintained for a reference time or more after the voice notifying unit 110 notifies the invisible user of the name of the menu or application service corresponding to the touched position through the voice.

With the man-machine interface apparatus 100 as described above, the invisible user may select the menu or the application service through the touch, the character, or the voice, and perform each menu or application service by confirming whether or not the menu or application service selected through the touch, the character, or the voice is the menu or application service desired by the invisible user. Therefore, when the invisible user uses a portable terminal, convenience of the invisible user may be improved.

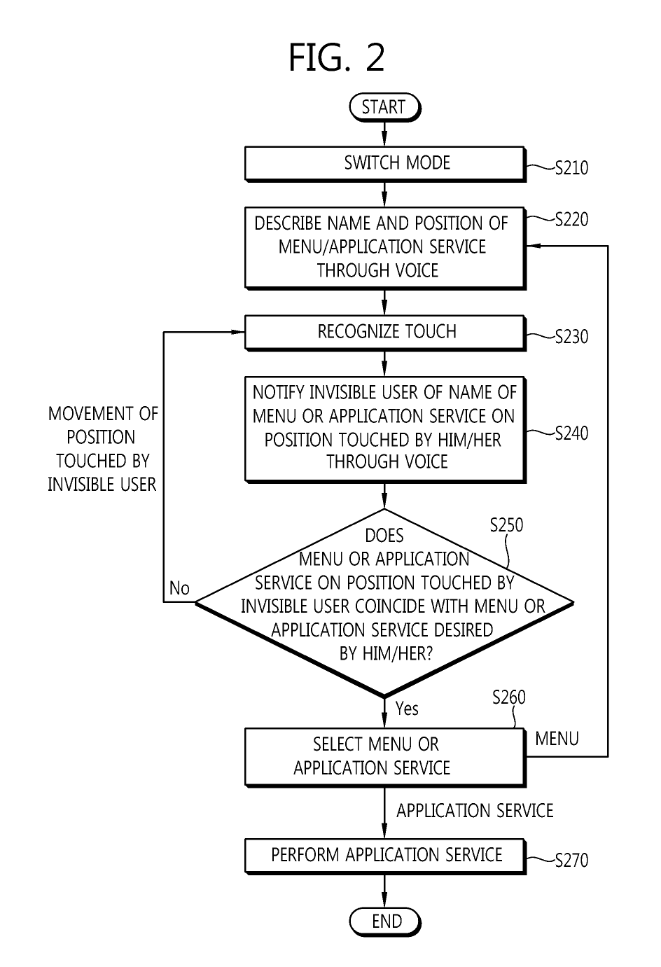

Hereinafter, a man-machine interface method according to another exemplary embodiment of the present invention will be described with reference to FIG. 2. FIG. 2 is a flow chart showing a man-machine interface method according to another exemplary embodiment of the present invention. In the present exemplary embodiment, a case in which the invisible user interfaces with a portable terminal through the touch will be described by way of example.

First, the man-machine interface apparatus 100 switches a mode of the portable terminal, for example, from a normal mode into an invisible user mode through operation of a switch included in the portable terminal, according to setting of the invisible user (S210). When the mode of the portable terminal is switched into the invisible user mode as described above, the man-machine interface apparatus 100 describes the names and the positions of each menu or application service through the voice (S220).

For example, when the man-machine interface apparatus 100 describes each menu or application service through the voice, it may divide the touch screen into a plurality of regions and map the positions of each menu or application service to positional numbers representing each region.

Thereafter, when the invisible user hears the voice description for the menu or the application service and then touches the position of the desired menu or application service with his/her finger, the man-machine interface apparatus 100 recognizes the touch by the invisible user (S230), and notifies the invisible user of the name of the menu or the application on the position touched by him/her through the voice (S240).

Next, the man-machine interface apparatus 100 determines whether the menu or the application service on the position touched by the invisible user coincides with the menu or application service desired by him/her (S250).

For example, when the invisible user hears the voice description for the menu or the application service and then touches the position of the desired menu or application service with his/her finger, the man-machine interface apparatus 100 may determine whether the menu or the application service on the position touched by the invisible user coincides with the menu or application service desired by him/her, according to whether or not the confirmation signal is received from the invisible user, without immediately performing the operation for the touched menu or application service.

For example, the man-machine interface apparatus 100 determines that the menu or the application service on the position touched by the invisible user is the menu or application service desired by him/her when the invisible user maintains his/her finger for the reference time or more, while fixing his/her finger at the position desired by him/her. For example, the man-machine interface apparatus 100 may also determine that the menu or the application service on the position touched by the invisible user is the menu or application service desired by him/her when the invisible user fixes his/her finger at the position desired by him/her and presses a selection indicator.

Here, the selection indicator may be positioned at a left or right corner of a lower portion of the touch screen or be provided as a separate button type.

When it is determined that the menu or the application service on the position touched by the invisible user is not the menu or application service desired by him/her, the invisible user moves the position of the touch in order to search for the menu or application desired by him/her, and the man-machine interface apparatus 100 again recognizes the touch (S230).

When it is determined that the menu or the application service on the position touched by the invisible user is the menu or application service desired by him/her, the man-machine interface apparatus 100 selects the corresponding menu or application service (S260). When the menu is selected, the man-machine interface apparatus 100 describes the name and the positions of the menu or the application through the voice using the method as described above (S220), and selects the menu or the application service.

That is, when the menu is selected, there are submenus or application services pertaining to the selected menu. Therefore, the man-machine interface apparatus 100 performs the touch recognition and the voice notification so that the invisible user again selects the submenus or the application services pertaining to the selected menu. When the application service is selected, the man-machine interface apparatus 100 performs the corresponding application service.

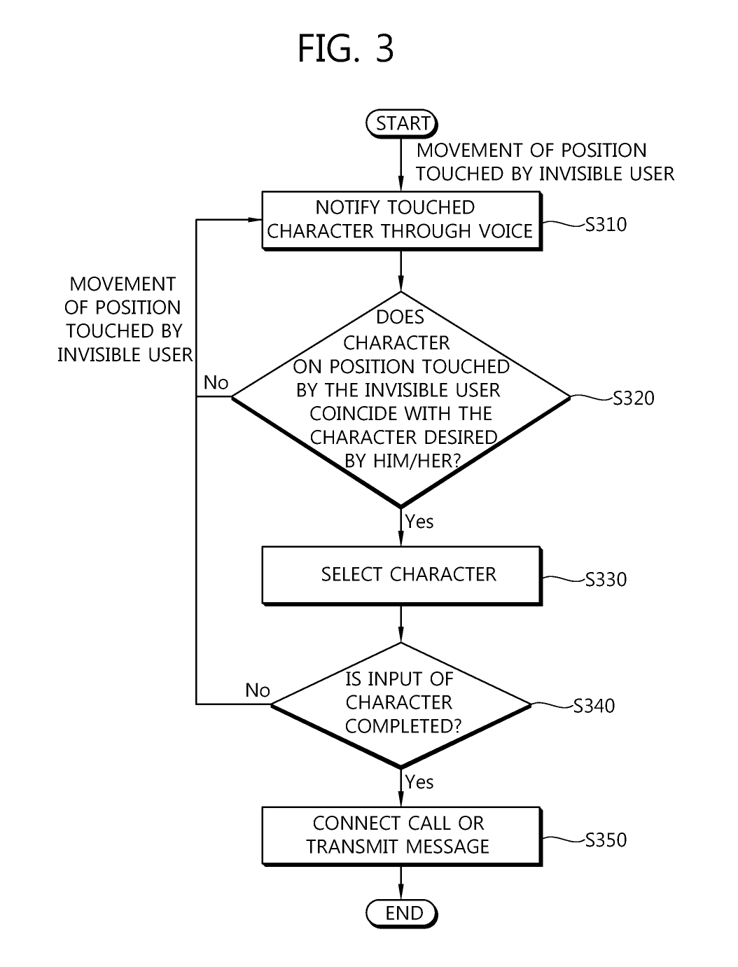

A man-machine interface method according to another exemplary embodiment of the present invention will be described with reference to FIG. 3. FIG. 3 is a flow chart describing a man-machine interface method according to another exemplary embodiment of the present invention. In the present exemplary embodiment, a process in which the man-machine interface apparatus 100 performs a call service or a message service through interface with the invisible user is described by way of example.

First, the man-machine interface apparatus 100 displays the keyboard for inputting a phone number or a character on the touch screen, notifies the invisible user of the character (including numerals) touched according to a moved position through the voice when the position touched by the invisible user is moved (S310), and determines whether the character on the position touched by the invisible user coincides with the character desired by him/her (S320).

The determining operation is performed identically to the S250 operation described above with reference to FIG. 2. When the character on the position touched by the invisible user does not coincide with the character desired by him/her, the invisible user moves the position of the touch in order to search for the character desired by him/her, and the man-machine interface apparatus 100 recognizes the touch to notify the invisible user of the touched character through the voice (S310).

When the character on the position touched by the invisible user coincides with the character desired by him/her, the man-machine interface apparatus 100 selects the corresponding character and determines whether the input of the characters is completed (S340). When the input of the characters is not completed, the man-machine interface apparatus 100 receives additional characters from the invisible user. When the input of the characters is completed, the man-machine interface apparatus 100 connects a call or transmits a message according to the input characters (S350).

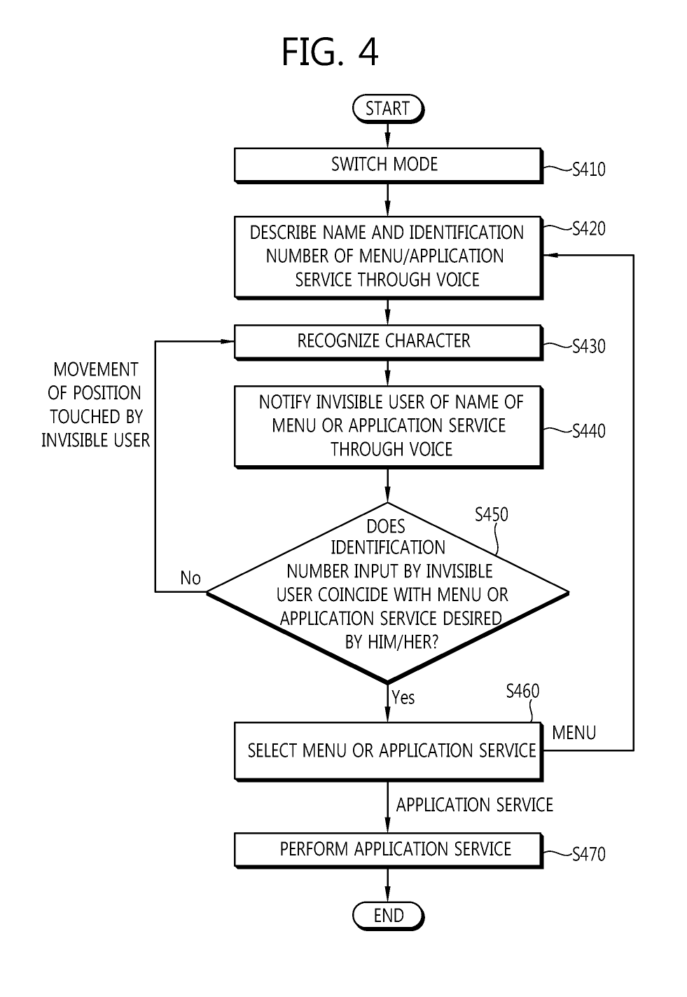

A man-machine interface method according to another exemplary embodiment of the present invention will be described with reference to FIG. 4. FIG. 4 is a flow chart describing a man-machine interface method according to another exemplary embodiment of the present invention. In the present exemplary embodiment, a case in which the invisible user interfaces with the portable terminal through the touch will be described by way of example.

First, the man-machine interface apparatus 100 switches a mode of the portable terminal, for example, from a normal mode into an invisible user mode through operation of a switch included in the portable terminal, according to the setting of the invisible user (S410). When the mode of the terminal is switched into the invisible user mode as described above, the man-machine interface apparatus 100 describes the names and the identification numbers of each menu and application service through the voice (S420).

The invisible user hears the names and the identification numbers of the menu or the application service and writes the identification number of the desired menu or application service on the touch screen by handwriting the character. The man-machine interface apparatus 100 recognizes the character (identification number) (S430), and notifies the invisible user of the name of the menu or application service corresponding to the identification number through the voice (S440). The man-machine interface apparatus 100 determines whether the identification number input by the invisible user is the identification number of the menu or application service desired by him/her (S450), and selects the menu or application service corresponding to the identification number when the identification number input by the invisible user is the identification number of the menu or application service desired by him/her (S460). When the menu is selected, the man-machine interface apparatus 100 repetitively performs the S420 operation, similar to the above-mentioned exemplary embodiment, and when the application service is selected, the man-machine interface apparatus 100 performs the application service (S470).

According to the exemplary embodiment of the present invention, the invisible user may more easily use the portable terminal.

Although the configuration of the present invention has been described in detail with reference to the exemplary embodiments and the accompanying drawings, it is only an example and may be variously modified in the scope of the present invention without departing from the spirit of the present invention. Therefore, the scope of the present invention should be not construed as being limited to the described exemplary embodiments but be defined by the appended claims as well as equivalents thereto.

What is claimed is:

1. A man-machine interface apparatus for an user, the man-machine interface apparatus comprising:
a touch recognizing unit recognizing a touch by the user; and
a voice notifying unit notifying the user of a name of a menu or application service corresponding to the touched position through a voice.

2. The man-machine interface apparatus of claim 1, further comprising an interface controlling unit performing the menu or application service corresponding to the touched position when the name notified through the voice is a name of a target menu or application service to be selected by the user.

3. The man-machine interface apparatus of claim 2, wherein the interface controlling unit determines that the name notified through the voice is the name of the target menu or application service to be selected by the user when a confirmation signal is inputted from the user.

4. The man-machine interface apparatus of claim 2, wherein the interface controlling unit determines that the name notified through the voice is the name of the target menu or application service to be selected by the user when the touch is maintained for a reference time or more.

5. The man-machine interface apparatus of claim 2, further comprising a selection button receiving an instruction from the user,
wherein the interface controlling unit determines that the name notified through the voice is the name of the target menu or application service to be selected by the user when the selection button is operated by the user.

6. The man-machine interface apparatus of claim 2, further comprising a transmitting/receiving and browsing unit performing communication with the outside and web browsing, according to a control of the interface controlling unit.

7. The man-machine interface apparatus of claim 1, wherein the voice notifying unit notifies the user of the name of the menu or the application service and a position of the menu or the application service on the touch recognizing unit through the voice to guide touch of the user.

8. The man-machine interface apparatus of claim 7, wherein the voice notifying unit notifies the user of the name and the position in the case in which a mode of a portable terminal is switched into an user mode.

9. The man-machine interface apparatus of claim 1, further comprising a character recognizing unit recognizing a character input by the user,
wherein the voice notifying unit notifies the user of the recognized character through the voice.

10. The man-machine interface apparatus of claim 9, further comprising an interface controlling unit receiving a recognition result of the touch or a recognition result of the character to provide the recognition result to the voice notifying unit.

11. The man-machine interface apparatus of claim 9, wherein any one of the character recognizing unit and the touch recognizing unit selected by the user is activated and operated.

12. A man-machine interface method for an user, the man-machine interface method comprising:
switching a mode into an user mode;
notifying the user of a name and a position of a menu or an application service through a voice; and
recognizing a touch by the user and notifying the user of a name of a menu or application service corresponding to a position of the touch through the voice.

13. The man-machine interface method of claim 12, further comprising performing the menu or application service corresponding to the position of the touch when the name notified through the voice is a name of a target menu or application service to be selected by the user.

14. The man-machine interface method of claim 13, wherein the performing includes determining that the name notified through the voice is the name of the target menu or application service to be selected by the user when the touch is maintained for a reference time or more.

15. The man-machine interface method of claim 13, wherein the performing includes determining that the name notified through the voice is the name of the target menu or application service to be selected by the user when a selection button receiving an instruction from the user is operated by the user.

16. A man-machine interface method for an user, the man-machine interface method comprising:
switching a mode into an user mode;
notifying the user of a name an identification number of a menu or an application service through a voice; and
recognizing a character written by the user and notifying the user of a name of a menu or application service corresponding to the recognized character through the voice.

17. The man-machine interface method of claim 16, further comprising performing the menu or application service corresponding to the recognized character when the name notified through the voice is a name of a target menu or application service to be selected by the user.

18. The man-machine interface method of claim 17, wherein the performing includes determining that the name notified through the voice is the name of the target menu or application service to be selected by the user when a confirmation signal is input from the user after the notifying.
